(19) United States
(12) Patent Application Publication
(10) Pub. No.: US 2006/0214433 A1
(43) Pub. Date: Sep. 28, 2006

(54) Dual-action latching device

(75) Inventors: Chin-Ming Chang, Taipei City (TW); Chi-Hsuan Hung, Taipei City (TW); Yao-Wen Yeh, Taipei City (TW)

Correspondence Address: BACON & THOMAS, PLLC, 625 SLATERS LANE, FOURTH FLOOR, ALEXANDRIA, VA, 22314, US

(73) Assignee: Tatung Company, Taipei City (TW)

(21) Appl. No.: 11/355,014

(22) Filed: Feb. 16, 2006

(30) Foreign Application Priority Data
Mar. 23, 2005 (TW) 094108955

(51) Int. Cl. E05C 19/10

(52) U.S. Cl. 292/128

(57) ABSTRACT

A dual-action latching device includes two vertical boards, a vertical moving latch, two horizontal poles, a horizontal fixed board, and two springs. Wherein the vertical moving latch of two sides board moves on the two vertical boards, that can impel the top latch or below latch to the cover, respectively, the two springs offer thrust to impel and orient one to slip horizontally and move on two horizontal poles again, and then the groove on imbedding and moving the latch vertically and slippery or putting the groove and orienting it, in order to be able to be used for fastening fixing it in the button trough of the host computer jointly separately.

### BACKGROUND OF THE INVENTION

1. Field of the Invention

The present invention relates to a latching device and, more particularly, to a dual-action latching device for a portable computer.

2. Description of the Related Art

A typical portable computer comprises a cover with a display screen and a host base. The host base comprises a keyboard set and a fastening slot. The cover includes a corresponding fastening hook for engaging with the fastening slot. Conventionally, the cover is pivoted on the host base and is capable of dual-axis rotation. Since the above mentioned fastening elements are permanent in their positions, when the display screen of the cover faces the host base and is pivoted down to abut the host base, the fastening hook may engage with the fastening slot; however, when the back of the display screen of the cover faces the host base and is pivoted down to abut the host base, the fastening hook cannot engage with the fastening slot.

Therefore, it is desirable to provide a dual-action latching device for a portable computer to mitigate and/or obviate the aforementioned problems.

### SUMMARY OF THE INVENTION

The dual-action latching device of the present invention is used for a cover of a portable computer, the cover comprising an upper shell, a lower shell and an inner space formed between the upper shell and the lower shell, the upper shell comprising an upper aperture, and the lower shell comprising a lower aperture corresponding to the upper aperture. The dual-action latching device comprises: at least one vertical guiding device, a vertical moving latch, at least one horizontal guiding device, a horizontal positioning block, and at least one elastic element. The at least one vertical guiding device is mounted on the upper cover and received in the inner space at a position corresponding to the upper aperture and the lower aperture. The vertical moving latch comprises at least one vertical guiding element, an upper latch, a lower latch, an upper positioning unit and a lower positioning unit, the at least one vertical guiding element capable of correspondingly vertically sliding on the at least one vertical guiding device to cause the upper latch to slide up and protrude from the upper aperture or to cause the lower latch to slide down and protrude from the lower aperture. The at least one horizontal guiding device is secured on the cover and received in the inner space. The horizontal positioning block comprises at least one horizontal guiding element and a positioning element, the at least one horizontal guiding element capable of correspondingly horizontally sliding on the at least one horizontal guiding device. The at least one elastic element provides an elastic force P to the horizontal positioning block so that the horizontal positioning block utilizes the at least one horizontal guiding element to correspondingly horizontally slide on the at least one horizontal guiding device, and causes the positioning element of the horizontal positioning block to selectively position at either the upper positioning unit or the lower positioning unit of the vertical moving latch.

The at least one vertical guiding device comprises two parallel vertical boards, a guiding column, and a locking screw, and the guiding column further comprises a thread correspondingly fastened with the locking screw so the locking screw can be used for adjusting tightness when the vertical moving latch slides vertically.

Furthermore, the vertical moving latch further comprises a guiding slot, and the two parallel sideboards are mounted at positions corresponding to the two parallel vertical boards and are able to vertically slide in the two vertical boards. The guiding slot is sleeved onto the guiding column and correspondingly slides vertically. The upper positioning unit and the lower positioning unit of the vertical moving latch are both positioning recesses and the positioning element of the horizontal positioning block is a positioning protrusion; or the upper positioning unit and the lower positioning unit of the vertical moving latch are both positioning protrusions and the positioning element of the horizontal positioning block is a positioning recess. The recess can be any shape such as rectangular recess, trapezoid recess, half-round recess, triangular recess . . . etc., or any other equal positioning recesses.

The at least one horizontal guiding device comprises two parallel horizontal rods, and the at least one horizontal guiding element of the horizontal positioning block comprises two apertures capable of separately and horizontally moving along two horizontal rods.

The upper latch and the lower latch of the vertical moving latch are both hooks, and each hook further comprises an oblique face.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a portable computer according to the present invention.

FIG. 2 is an exploded view of dual-action latching device according to the present invention.

FIG. 3 is a cross-sectional view of a dual-action latching device with a portion shown in phantom lines, according to the present invention.

FIG. 4 is another cross-sectional view of a dual-action latching device with a portion shown in phantom lines, according to the present invention.

### DETAILED DESCRIPTION OF THE PREFERRED EMBODIMENT

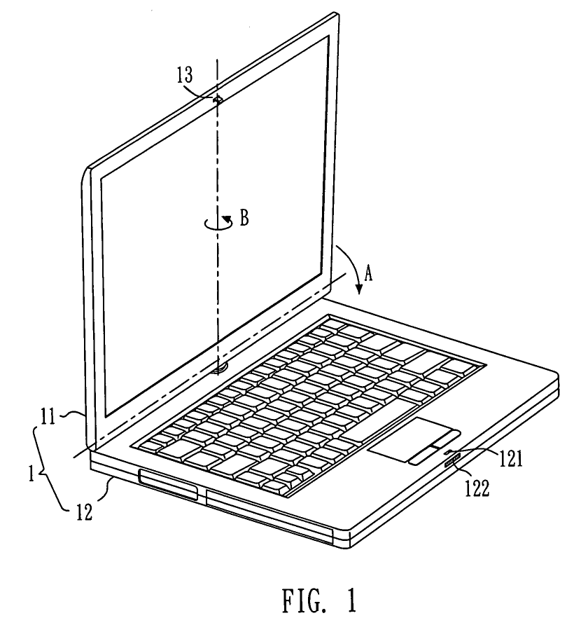

FIG. 1 is a perspective view of a portable computer with a latching device. A portable computer 1 can be used as both a notebook computer and a tablet computer. The computer 1 comprises a cover 11 and a host base 12. The cover 11 is pivoted on the host base 12 and is able to pivot relative to the host base 12.

However, the host base 12 and the cover 11 can be locked together by a dual-action latching device 13 formed on the cover 11, with a fastening slot 121 correspondingly defined in the host base 12. When the dual-action latching device 13 is engaged with the fastening slot 121, a release button 122 moves in a corresponding manner. When the cover 11 is to be pivoted up from moved towards the host base 12 along direction A (shown in FIG. 1) for use as a notebook computer screen, the dual-purpose latching device 13 slides up; when the cover 11 is rotated along axis direction B (as shown in FIG. 1) and faces against the host base 12 for use as a tablet computer screen, the dual-purpose latching device 13 slides down.

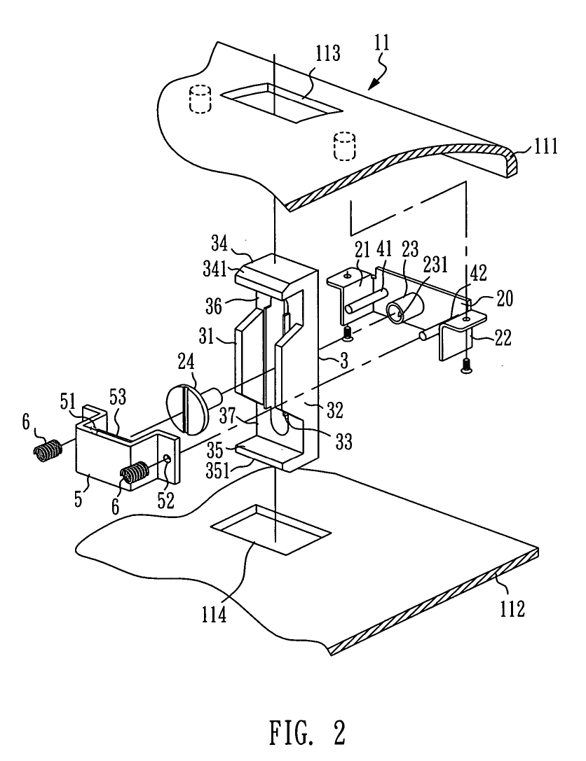

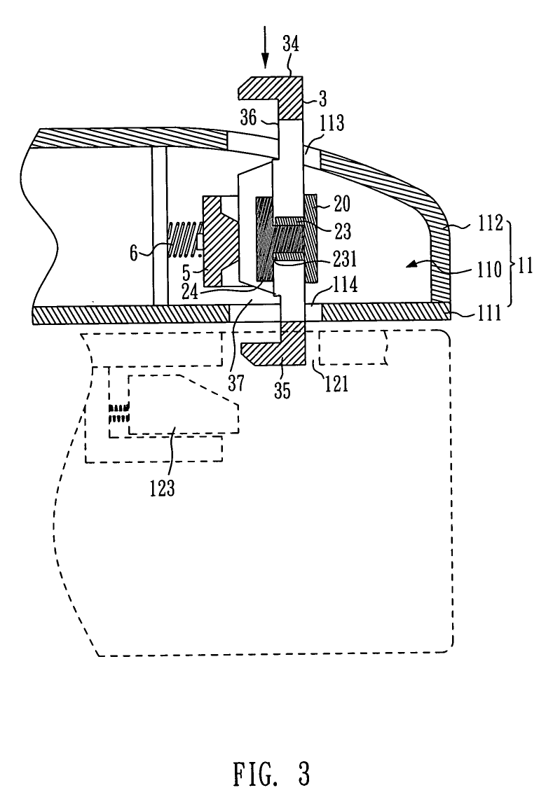

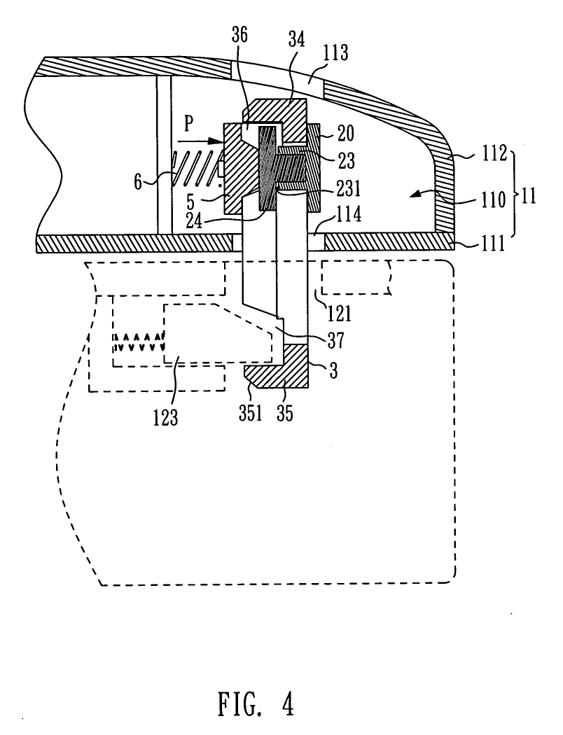

Please refer to FIG. 2, FIG. 3, and FIG. 4. The cover 11 comprises an upper shell 111, a lower shell 112, and an inner space 110, and the dual-action latching device 13 is placed between the upper shell 111 and the lower shell 112. The upper shell 111 further comprises an upper aperture 113, and the lower shell 112 further comprises a lower aperture 114 that corresponds to the upper aperture 113.

The dual-action latching device 13 further comprises three vertical guiding devices 21, 22, 23, a vertical moving latch 3, two horizontal guiding devices 41, 42, a horizontal positioning block 5, and two elastic elements 6. In this embodiment, the three vertical guiding devices 21, 22, 23 are formed on a stabilizing board 20, which is mounted in the inner space 110 of the cover 11 at a position corresponding to the upper aperture 113 and the lower aperture 114. The vertical moving latch 3 comprises three vertical guiding elements 31, 32, 33, an upper latch 34, a lower latch 35, an upper positioning unit 36, and a lower positioning unit 37. The three vertical guiding elements 31, 32, 33 correspondingly and vertically slide on the three vertical guiding devices 21, 22, 23, forcing the upper latch 34 to slide up to protrude from the upper aperture 113, or forcing the lower latch 35 to slide up to protrude from the lower aperture 114. The two horizontal guiding devices 41, 42 are two parallel rods that are formed on the stabilizing board 20, and each is located between a respective one of the guiding devices 21, 22 and the guiding device 23. The horizontal positioning block 5 comprises two horizontal guiding elements 51, 52, and a positioning element 53. The two horizontal guiding elements 51, 52 are two apertures that correspondingly and horizontally slide on the two horizontal guiding devices 41, 42. In this embodiment, two elastic elements 6, such as coil springs, provide an elastic force to the horizontal positioning block 5 so that the horizontal positioning block 5 can utilize the two horizontal guiding elements 51, 52 to horizontally slide on the two horizontal guiding devices 41, 42 and selectively cause the positioning element 53 of the horizontal positioning block 5 to position at one of the upper positioning unit 36 and the lower positioning unit 37 of the vertical moving latch 3. In this embodiment, the positioning element 53 of the horizontal positioning block 5 is a positioning protrusion, and the upper positioning unit 36 and the lower positioning unit 37 of the vertical moving latch 3 are both positioning recesses.

The vertical guiding devices 21, 22 of the dual-action latching device 13 are parallel vertical boards 21, and the vertical guiding device 23 is a guiding column. The guiding column 23 comprises a locking screw 24, and an inner thread corresponding to the locking screw 24. The locking screw 24 is used for adjusting tightness when the vertical moving latch 3 slides vertically.

The three vertical guiding elements of the vertical moving latch 3 are two parallel side boards 31, 32 and a guiding slot 33, and the two parallel side boards 31, 32 are mounted at positions corresponding to the two parallel vertical boards and are able to vertically slide in the two vertical boards 21, 22. The guiding slot 33 is hooked on the guiding column 23 and correspondingly slides vertically, as shown in FIG. 3.

The upper latch and the lower latch of the vertical moving latch 3 are both first hooks 34, 35 which have an oblique face 341, 351 for engaging with a second hook 123 at the rear end of the releasing button 122, as shown in FIG. 4.

Therefore, the dual-action latching device of the present invention may be utilized in a notebook computer or a tablet computer; the two parallel side boards 31, 32 of vertical moving latch 3 vertically slide on the two vertical boards 21, 22 so that the hook of the upper latch 34 or the hook of the lower latch 35 separately protrude from the upper side or the lower side of the covering 11, and the two springs 6 provide a force P to force the horizontal positioning block 5 to horizontally slide on the two horizontal rods 41, 42 to engage with the upper recess 36 or lower recess 37 of the vertical moving latch 3 for locking with the fastening slot 121 of the host base 12.

Although the present invention has been explained in relation to its preferred embodiment, it is to be understood that many other possible modifications and variations can be made without departing from the spirit and scope of the invention as hereinafter claimed.

What is claimed is:

1. A dual-action latching device for a cover of a portable computer, the cover comprising an upper shell, a lower shell and an inner space formed between the upper shell and the lower shell, the upper shell comprising an upper aperture, the lower shell comprising a lower aperture corresponding to the upper aperture; the dual-action latching device comprising:
at least one vertical guiding device mounted on the cover and received in the inner space at a position corresponding to the upper aperture and the lower aperture;
a vertical moving latch comprising at least one vertical guiding element, an upper latch, a lower latch, an upper positioning unit and a lower positioning unit, the at least one vertical guiding element capable of correspondingly vertically sliding on the at least one vertical guiding device to cause the upper latch to slide up and protrude from the upper aperture or to cause the lower latch to slide down and protrude from the lower aperture;
at least one horizontal guiding device fixed on the cover and received in the inner space;
a horizontal positioning block comprising at least one horizontal guiding element and a positioning element, the at least one horizontal guiding element capable of correspondingly horizontally sliding on the at least one horizontal guiding device; and
at least one elastic element for providing an elastic force to the horizontal positioning block so that the horizontal positioning block utilizes the at least one horizontal guiding element to correspondingly horizontally slide on the at least one horizontal guiding device, and causes the positioning element of the horizontal positioning block to selectively position at one of the upper positioning unit and the lower positioning unit of the vertical moving latch.

2. The dual-action latching device as claimed in claim 1 wherein the at least one vertical guiding device comprises two parallel vertical boards, the at least one vertical guiding element of the vertical moving latch comprises two parallel side boards movably mounted inside an inner side between the two parallel vertical boards.

3. The dual-action latching device as claimed in claim 1 wherein the at least one vertical guiding device comprises a guiding column, the at least one vertical guiding element of the vertical moving latch comprises a guiding slot sleeved onto the guiding column and vertically moving along the guiding column.

4. The dual-action latching device as claimed in claim 1 wherein the at least one vertical guiding device further comprises a locking screw, the guiding column further comprises a thread correspondingly fastened with the locking screw.

5. The dual-action latching device as claimed in claim 1 wherein the upper latch and the lower latch of the vertical moving latch are both hooks.

6. The dual-action latching device as claimed in claim 5, wherein each hook further comprises an oblique face.

7. The dual-action latching device as claimed in claim 1 wherein the upper positioning unit and the lower positioning unit of the vertical moving latch are both positioning recesses, and the positioning element of the horizontal positioning block is a positioning protrusion.

8. The dual-action latching device as claimed in claim 1 wherein the at least one horizontal guiding device comprises two parallel horizontal rods, the at least one horizontal guiding element of the horizontal positioning block comprises two apertures capable of respectively sleeving onto the two parallel horizontal rods and horizontally moving along the two parallel horizontal rods.

9. The dual-action latching device as claimed in claim 1 wherein the at least one elastic element is a coil spring.

10. The dual-action latching device as claimed in claim 1 wherein the portable computer is used as a notebook computer and a tablet computer.
